(19) United States
(12) Patent Application Publication
(10) Pub. No.: US 2009/0127175 A1
(43) Pub. Date: May 21, 2009

(54) Water aerating device for aquarium

(76) Inventor: Hsueh Lee Tsai, Yunlin Hsien (TW)

Correspondence Address: CHARLES E. BAXLEY, ESQUIRE, 90 JOHN STREET, SUITE 309, NEW YORK, NY, 10038, US

(21) Appl. No.: 11/985,759

(22) Filed: Nov. 16, 2007

(51) Int. Cl. A01K 63/04

(52) U.S. Cl. 210/167.21

(57) ABSTRACT

A water aerating device for an aquarium includes a pumping device having an impeller for pumping a water, a receptacle attached to the pumping device, a tube disposed on the pumping device for forming an annular space between the receptacle and the tube which has a bore for supplying the water toward the impeller, a tubular member extended in the receptacle for forming an annular chamber between the tubular member and the receptacle and an annular passageway between the tubular member and the tube, and for allowing the carbon dioxide to be drawn into the tube and to be recycled and to be minimized into a large amount of smaller air bubbles.

### BACKGROUND OF THE INVENTION

1. Field of the Invention

The present invention relates to a water aerating device for an aquarium, and more particularly to a water aerating device for attaching to an aquarium and for suitably agitating the water and the carbon dioxide and/or the air and for suitably supplying the carbon dioxide and/or the air into the water contained within the container and for suitably supplying the carbon dioxide and/or the air to the water plants or the water weeds received in the container.

2. Description of the Prior Art

Typical aquarium facilities comprise a pump disposed in a chamber of a container for circulating the water contained within the container and for pumping fresh air or carbon dioxide into the container and thus for airing or aerating purposes.

For example, U.S. Pat. No. 6,523,498 to Shyu discloses one of the typical aquariums having a powerless air pumping device and comprising an impeller disposed in a chamber of a container and arranged in a water flowing path for being powered by the flowing water.

However, the water flowing through the water flowing path has a limited flowing speed such that the impeller may not be suitably rotated or driven by the flowing water.

In addition, the impeller may not be used to suitably agitate the water and the carbon dioxide and/or the air and may not suitably supply the carbon dioxide and/or the air into the water contained within the container and also may not suitably supply the carbon dioxide and/or the air to the water plants or the water weeds received in the container.

The present invention has arisen to mitigate and/or obviate the afore-described disadvantages of the conventional water aerating devices for aquarium facilities.

### SUMMARY OF THE INVENTION

The primary objective of the present invention is to provide a water aerating device for attaching to an aquarium and for suitably agitating the water and the carbon dioxide and/or the air and for suitably supplying the carbon dioxide and/or the air into the water contained within the container and for suitably supplying the carbon dioxide and/or the air to the water plants or the water weeds received in the container.

The other objective of the present invention is to provide a water aerating device for recycling the carbon dioxide and for agitating and minimizing the carbon dioxide and/or the air into a large amount of smaller air bubbles.

In accordance with one aspect of the invention, there is provided a water aerating device for an aquarium comprising a pumping device for attaching a container of the aquarium, and including at least one outlet openings, and an impeller for pumping and impelling a water out through the outlet opening of the pumping device, a receptacle attached to the pumping device for receiving the water pumped and impelled by the impeller, and including at least one orifice formed therein for allowing the water to flow out through the orifice of the receptacle, a tube disposed in the receptacle and disposed on the pumping device for forming an annular space between the receptacle and the tube and for receiving the water pumped by the impeller, the tube including a bore formed therein for receiving the water and directed toward the impeller for supplying the water toward the impeller and for allowing the water to be pumped and impelled by the impeller, the receptacle including a tubular member extended in an upper portion of the receptacle for forming an annular chamber between the tubular member and the receptacle, and for forming an annular passageway between the tubular member and the tube, and the annular passageway between the tubular member and the tube being communicating with the annular space between the receptacle and the tube for allowing a carbon dioxide to flow upwardly through the annular space between the receptacle and the tube and the annular passageway between the tubular member and the tube and for allowing the carbon dioxide to be drawn into the bore of the tube and to be mixed with the water and to be recycled, and the receptacle including an entrance formed therein and communicating with the annular chamber of the receptacle, and coupled to a carbon dioxide reservoir for receiving the carbon dioxide and for allowing the carbon dioxide to flow into the annular chamber of the receptacle and to be drawn into the bore of the tube and to be supplied into the water that flows into the bore of the tube.

The tube includes at least one protrusion extended outwardly from the tube for agitating the water flowing into the annular space of the receptacle and for generating an eddy current.

The receptacle includes an outlet member having at least one orifice formed therein for allowing the water pumped and impelled by the impeller to flow out through the orifice of the outlet member and to flow into the receptacle.

The receptacle includes a rotary member rotatably disposed in the outlet member and rotatable relative to the receptacle, the rotary member includes at least one aperture formed therein for rotatably and selectively aligning with the orifice of the outlet member and for allowing the water to selectively flow out through the orifice of the outlet member.

The rotary member includes at least one fin extended therein for being actuated by the water pumped and impelled by the impeller and for allowing the rotary member to be rotated by the water flowing through the receptacle. The receptacle includes at least two housing members coupled together.

The receptacle includes a cover disposed on top and having a hollow pipe extended upwardly therefrom and aligned with the tube, and a floating device slidably attached to the pipe of the cover. The floating device includes a conduit extended downwardly from a float and slidably engaged with the pipe for allowing the float to be adjusted up and down relative to the pipe.

The floating device includes at least one water inlet for receiving the water in an upper portion of the container and for allowing the water to flow into the float and to flow through the conduit and the pipe of the cover and to flow into the bore of the tube.

The floating device includes a cap rotatably attached to the float and having a peripheral fence extended downwardly therefrom and rotatably engaged into the float, and having at least one perforation formed therein for adjustably aligning with the water inlet of the float.

The float includes a groove formed in the outer peripheral wall, and the cap includes a peripheral latch rotatably engaged into the groove of the float for rotatably attaching the cap to the float. The float includes a compartment formed in an outer peripheral wall, and a rotary wheel rotatably disposed in the compartment of the float and having at least one passage formed therein.

The pumping device includes a casing having a chamber formed in the casing for receiving the impeller. The receptacle includes a ring member disposed on the tube and engaged between the tubular member and the tube, and the ring member includes a notch formed therein and communicating with the annular passageway between the tubular member and the tube for partially blocking the annular passageway between the tubular member and the tube.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a cross sectional view illustrating the operation of a water aerating device that is attached to an aquarium;

FIG. 2 is an exploded view of the water aerating device;

FIG. 3 is a perspective view illustrating a paddle wheel of the water aerating device;

FIG. 4 is a perspective view of the water aerating device;

FIG. 5 is a cross sectional view of the water aerating device taken along lines 5-5 of FIG. 4;

FIGS. 6, 7 are cross sectional views taken along lines 6-6, and 7-7 of FIG. 5 respectively;

FIG. 8 is an enlarged partial cross sectional view illustrating the operation of the water aerating device;

FIG. 9 is a cross sectional view similar to FIG. 6, illustrating the operation of the water aerating device; and

FIGS. 10, 11, 12 are cross sectional views similar to FIG. 7, illustrating the operation of the water aerating device.

### DETAILED DESCRIPTION OF THE PREFERRED EMBODIMENT

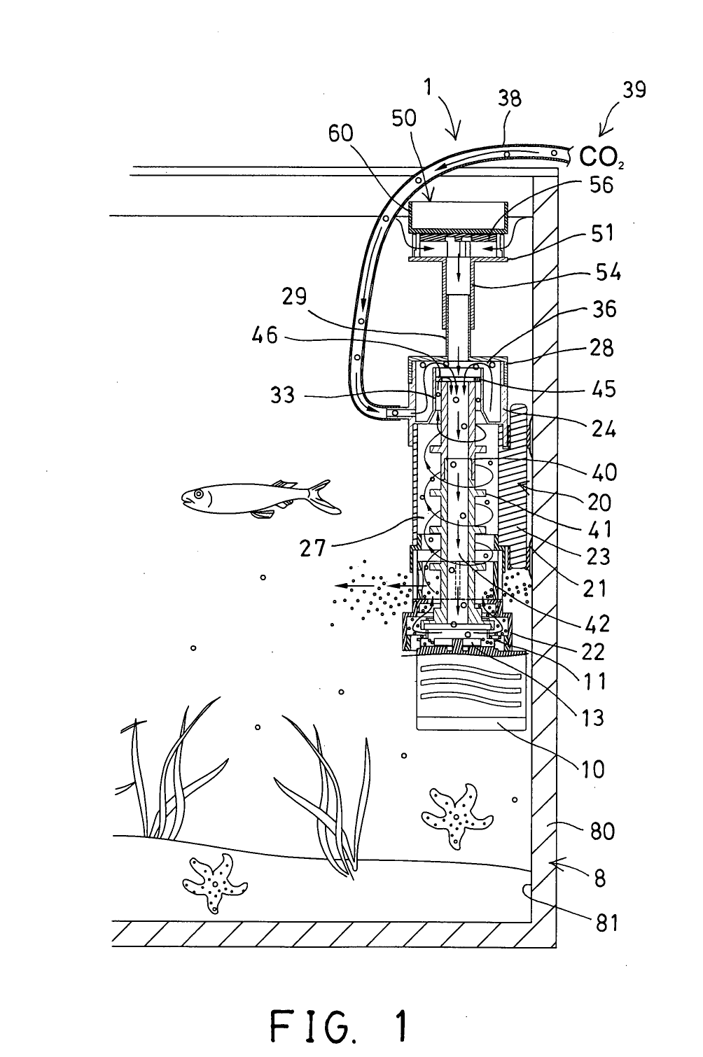

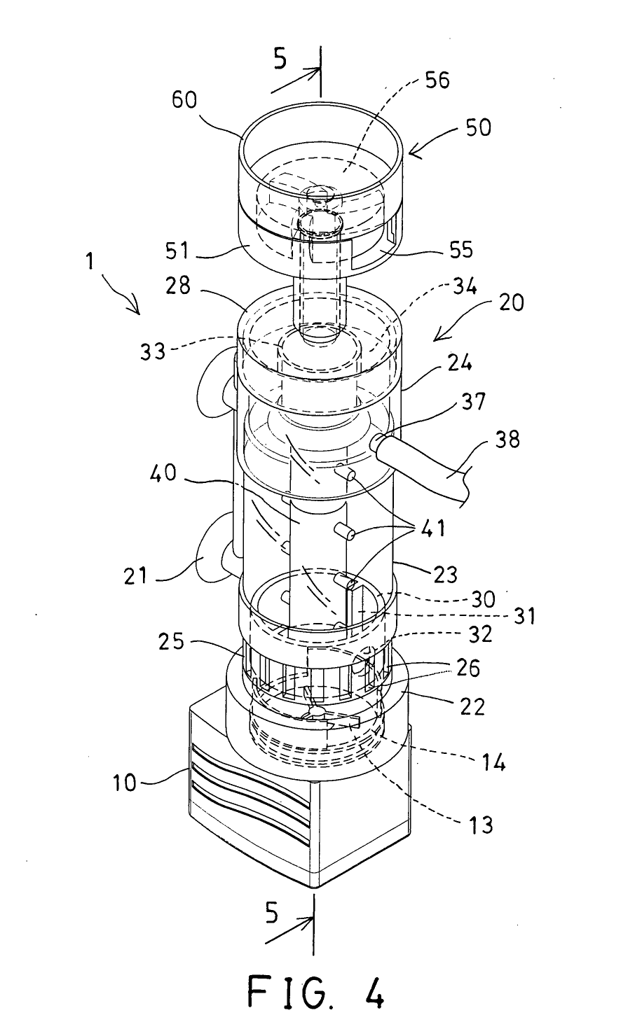

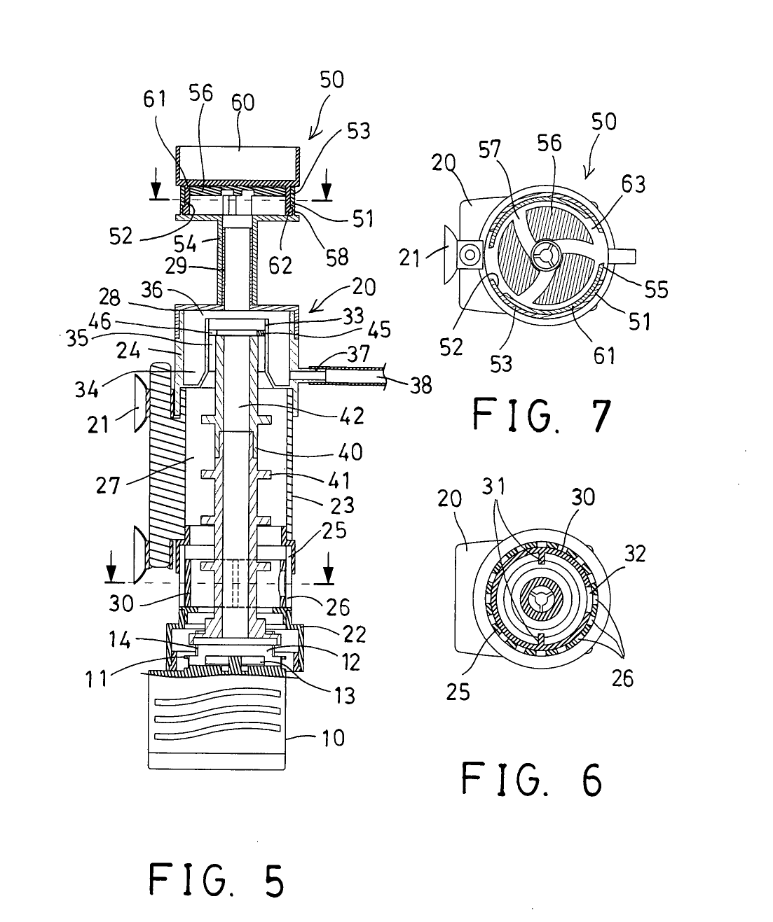

Referring to the drawings, and initially to FIGS. 1-5, a water aerating device 1 in accordance with the present invention is provided for attaching to an aquarium 8 which comprises a container 80 including a chamber 81 formed therein for receiving water and fish 88, and comprises a pumping device 10 for attaching to the interior of the container 80 with hooks or latches or fasteners or sucking cups (not shown) or the like, the pumping device 10 includes a casing 11 formed or provided on top or on the upper portion thereof and having a chamber 12 formed in the casing 11, and includes a powered or motorized impeller 13 for pumping or impelling the water out through one or more outlet openings 14 of the casing 11 (FIG. 1) by such as the eccentric forces, in which the openings 14 of the casing 11 are communicating with the chamber 12 of the casing 11.

A receptacle 20 may be attached to the interior of the container 80 with hooks or latches or fasteners (not shown) or sucking cups 21 or the like, and disposed or attached to the casing 11 of the pumping device 10, the receptacle 20 include one or more (such as three) housing members 22, 23, 24 assembled or secured or coupled together with such as force-fitted engagements, hooks or latches or fasteners (not shown) or with adhesive materials, or by welding processes, and may further include a screen or an outlet member 25 such as disposed between and secured to the housing members 22, 23 with such as force-fitted engagements, hooks or latches or fasteners (not shown) or with adhesive materials, or by welding processes, and having a number of orifices 26 formed therein for allowing the water to be pumped or impelled by the powered or motorized impeller 13 to flow out through the orifices 26 of the outlet member 25 of the receptacle 20 (FIG. 1).

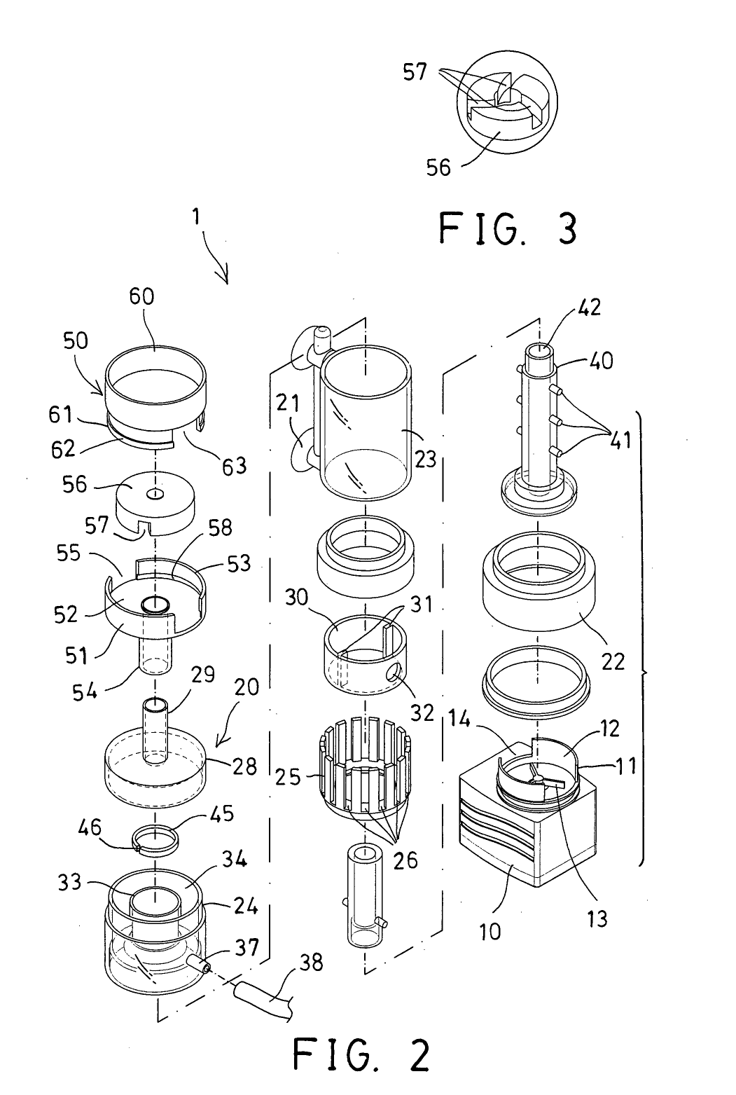

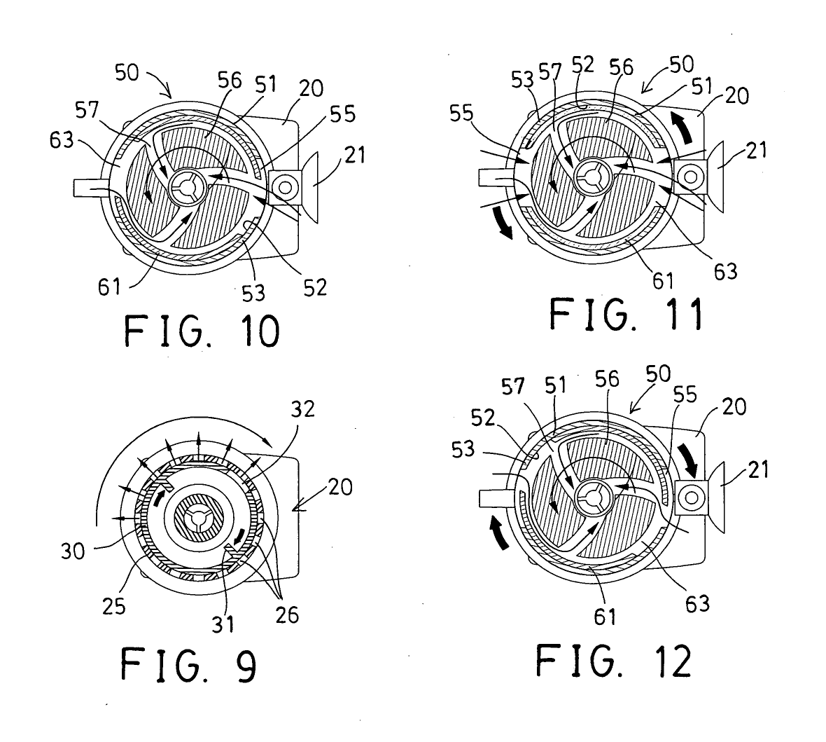

As shown in FIGS. 2, 4-6 and 9, a rotary member 30 is rotatably disposed in the receptacle 20, and particularly disposed in the outlet member 25 of the receptacle 20 and rotatable relative to the receptacle 20. For example, the rotary member 30 includes one or more fins 31 extended therein, such as extended radially therein for being actuated by the water pumped or impelled by the powered or motorized impeller 13 and for allowing the rotary member 30 to be rotated or driven by the water flowing through the receptacle 20. The rotary member 30 includes one or more apertures 32 formed therein for rotatably or selectively aligning with the orifices 26 of the outlet member 25 of the receptacle 20 (FIG. 9) and for allowing the water to cyclically flow out through the orifices 26 of the outlet member 25 of the receptacle 20 and thus to suitably or evenly distribute the water out through the orifices 26 of the outlet member 25 of the receptacle 20.

The receptacle 20 may include a tube 40, such as a hollow tube 40 disposed or extended therein, such as disposed concentrically in the receptacle 20 and disposed on the casing 11 for forming an annular space 27 between the receptacle 20 and the tube 40 (FIGS. 1, 5, 8), and includes one or more protrusions 41 extended outwardly from the tube 40 for agitating the water and for forming or generating an eddy current (FIG. 1), and thus for suitably agitating the water and the carbon dioxide and/or the air contained within the water in order to suitably agitate or to minimize the carbon dioxide and/or the air into a large amount of smaller air bubbles. The receptacle 20 may include a cover 28 disposed on top thereof and having a hollow pipe 29 extended upwardly therefrom and preferably aligned with the tube 40.

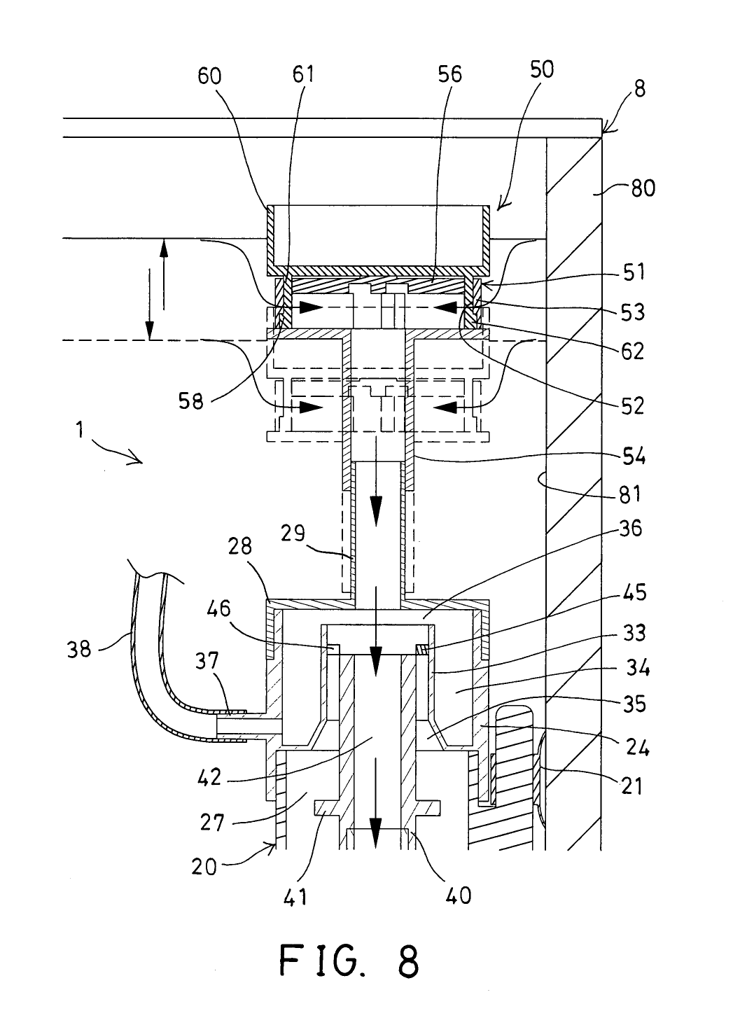

The tube 40 includes a bore 42 formed therein and aligned with or directed toward the pipe 29 of the cover 28 for receiving the water from the pipe 29 of the cover 28 (FIG. 8), and also aligned with or directed toward or communicating with the chamber 12 of the casing 11 for directing or supplying the water toward the impeller 13 and for allowing the water to be pumped or impelled by the impeller 13 and then to flow out through the orifices 26 of the outlet member 25 of the receptacle 20. It is preferable that the receptacle 20 includes a tubular member 33 extended in such as the upper portion thereof or the upper housing member 24 for forming an annular chamber 34 between the tubular member 33 and the upper housing member 24, and also for forming an annular passageway 35 between the tubular member 33 and the tube 40, and communicating with the annular space 27 between the receptacle 20 and the tube 40 and arranged for allowing the carbon dioxide and/or the air to flow upwardly through the annular passageway 35 between the tubular member 33 and the tube 40.

As shown in FIGS. 1, 5, 8, the upper portion of the tubular member 33 is slightly lower than the upper portion of the receptacle 20 and/or slightly lower than the cover 28 for forming a space or a gap 36 between the tubular member 33 and the cover 28, and the receptacle 20 may include an entrance 37 formed or provided in such as the upper portion thereof or the upper housing member 24 and communicating with the annular chamber 34 of the upper housing member 24, and coupled to an air or carbon dioxide reservoir 39 (FIG. 1) with a hose 38 for receiving the air and/or the carbon dioxide and for allowing the air and/or the carbon dioxide to flow or to be drawn into the annular chamber 34 of the upper housing member 24, and to flow through the gap 36 between the tubular member 33 and the cover 28 and then to be drawn into the bore 42 of the tube 40 and to be mixed or blended or supplied into the water that flows into the tube 40.

A ring member 45 is disposed or engaged onto the upper portion of the tube 40, and disposed or engaged between the tubular member 33 and the tube 40, and includes a notch 46 formed therein and communicating with the annular passageway 35 between the tubular member 33 and the tube 40 for partially blocking or closing the upper portion of the annular passageway 35 between the tubular member 33 and the tube 40 and for allowing the air and/or the carbon dioxide in the annular space 27 between the receptacle 20 and the tube 40 to flow or to be drawn through the notch 46 of the ring member 45 and then to be drawn into the bore 42 of the tube 40 (FIG. 1), such that the air and/or the carbon dioxide separated from the water and in the annular space 27 between the receptacle 20 and the tube 40 may be drawn into the water supplied into the bore 42 of the tube 40 and may be recycled.

A floating device 50 includes a float 51 having a compartment 52 formed or provided in an outer peripheral wall 53, and includes a conduit 54 extended downwardly therefrom and slidably engaged into or onto the outer peripheral portion of the pipe 29 of the cover 28 for allowing the float 51 to slide or to be adjusted up and down relative to the pipe 29 of the cover 28 (FIG. 8), and includes one or more water inlets 55 formed in such as the outer peripheral wall 53 for allowing the water in the upper portion of the container 80 to recycle or to flow into the compartment 52 of the float 51 and then to flow through the conduit 54 and the pipe 29 of the cover 28 and then to flow into the bore 42 of the tube 40. A paddle device or rotary wheel 56 is rotatably disposed in the compartment 52 of the float 51 and includes one or more (such as three) radially extended or helical passages 57 formed therein (FIGS. 3, 7, 10-12).

In operation, the water in the upper portion of the container 80 may flow through the water inlets 55 of the float 51 and may then flow into the compartment 52 of the float 51, and the water may then flow into the passages 57 of the rotary wheel 56 in order to impel or to rotate the rotary wheel 56 relative to the float 51. The float 51 may include a groove 58 formed in such as the inner peripheral portion of the outer peripheral wall 53, and may further include a cap 60 rotatably disposed or attached onto the float 51 and having a peripheral fence 61 extended downwardly therefrom and rotatably engaged into the compartment 52 of the float 51, and having a peripheral latch 62 extended radially and outwardly therefrom and rotatably engaged into the groove 58 of the float 51, and thus for rotatably attaching or securing the cap 60 onto the float 51, and having one or more perforations 63 formed therein for selectively or adjustably aligning or engaging with the water inlets 55 of the float 51.

For example, as shown in FIGS. 7 and 10-12, the cap 60 may be rotated or adjusted relative to the float 51 in order to adjust the opening side or width or dimension of the water inlets 55 of the float 51 and so as to adjust the water flowing speed or flowing quantity through the water inlets 55 of the float 51, and thus for allowing the water drawn or supplied into the bore 42 of the tube 40 may be suitably adjusted. As shown in FIG. 8, the float 51 of the floating device 50 may be floated or buoyed on top of the water contained within the upper portion of the chamber 81 of the container 80 for allowing only the water at the upper portion of the chamber 81 of the container 80 to flow through the water inlets 55 of the float 51 and then to flow into the compartment 52 of the float 51, and thus to be supplied into the bore 42 of the tube 40 in order to be pumped and impelled by the impeller 13.

In operation, the water supplied into the compartment 52 of the float 51 may be drawn through the conduit 54 and the pipe 29 of the cover 28 and may then be drawn into the bore 42 of the tube 40, and may then be drawn or forced to flow out through the openings 14 of the casing 11 and then to flow into the lower portion of the chamber 81 of the container 80 again. A portion of the water may be contained or received within the annular space 27 between the receptacle 20 and the tube 40 and may be caused to generate an eddy current by the powered or motorized impeller 13 and/or the protrusions 41 of the tube 40, and for allowing a portion of the air and/or the carbon dioxide, particularly the larger bubbles of the air and/or the carbon dioxide to be separated from the water and to be drawn through the notch 46 of the ring member 45 and then to be drawn into the bore 42 of the tube 40 such that the air and/or the carbon dioxide separated from the water and in the annular space 27 between the receptacle 20 and the tube 40 may be suitably recycled and may be suitably agitated or minimized into a large amount of smaller air bubbles.

Accordingly, the water aerating device in accordance with the present invention may be provided for attaching to an aquarium and for suitably agitating the water and the carbon dioxide and/or the air and for suitably supplying the carbon dioxide into the water contained within the container and for suitably supplying the carbon dioxide and/or the air to the water plants or the water weeds received in the container.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A water aerating device for an aquarium comprising:
a pumping device for attaching a container of the aquarium, and including at least one outlet openings, and an impeller for pumping and impelling a water out through said at least one outlet opening of said pumping device,
a receptacle attached to said pumping device for receiving the water pumped and impelled by said impeller, and including at least one orifice formed therein for allowing the water to flow out through said at least one orifice of said receptacle,
a tube disposed in said receptacle and disposed on said pumping device for forming an annular space between said receptacle and said tube and for receiving the water pumped by said impeller, said tube including a bore formed therein for receiving the water and directed toward said impeller for supplying the water toward said impeller and for allowing the water to be pumped and impelled by said impeller,
said receptacle including a tubular member extended in an upper portion of said receptacle for forming an annular chamber between said tubular member and said receptacle, and for forming an annular passageway between said tubular member and said tube, and said annular passageway between said tubular member and said tube being communicating with said annular space between said receptacle and said tube for allowing a carbon dioxide to flow upwardly through said annular space between said receptacle and said tube and said annular passageway between said tubular member and said tube and for allowing the carbon dioxide to be drawn into said bore of said tube, and
said receptacle including an entrance formed therein and communicating with said annular chamber of said receptacle, and coupled to a carbon dioxide reservoir for receiving the carbon dioxide and for allowing the carbon dioxide to flow into said annular chamber of said receptacle and to be drawn into said bore of said tube and to be supplied into the water that flows into said bore of said tube.

2. The water aerating device as claimed in claim 1, wherein said tube includes at least one protrusion extended outwardly from said tube for agitating the water flowing into said annular space of said receptacle and for generating an eddy current.

3. The water aerating device as claimed in claim 1, wherein said receptacle includes an outlet member having at least one orifice formed therein for allowing the water pumped and impelled by said impeller to flow out through said at least one orifice of said outlet member.

4. The water aerating device as claimed in claim 1, wherein said receptacle includes a rotary member rotatably disposed in said outlet member and rotatable relative to said receptacle, said rotary member includes at least one aperture formed therein for rotatably and selectively aligning with said at least one orifice of said outlet member and for allowing the water to selectively flow out through said at least one orifice of said outlet member.

5. The water aerating device as claimed in claim 4, wherein said rotary member includes at least one fin extended therein for being actuated by the water pumped and impelled by said impeller and for allowing said rotary member to be rotated by the water flowing through said receptacle.

6. The water aerating device as claimed in claim 1, wherein said receptacle includes at least two housing members coupled together.

7. The water aerating device as claimed in claim 1, wherein said receptacle includes a cover disposed on top and having a hollow pipe extended upwardly therefrom and aligned with said tube, and a floating device slidably attached to said pipe of said cover.

8. The water aerating device as claimed in claim 7, wherein said floating device includes a conduit extended downwardly from a float and slidably engaged with said pipe for allowing said float to be adjusted up and down relative to said pipe.

9. The water aerating device as claimed in claim 8, wherein said floating device includes at least one water inlet for receiving the water in an upper portion of the container and for allowing the water to flow into said float and to flow through said conduit and said pipe of said cover and to flow into said bore of said tube.

10. The water aerating device as claimed in claim 9, wherein said floating device includes a cap rotatably attached to said float and having a peripheral fence extended downwardly therefrom and rotatably engaged into said float, and having at least one perforation formed therein for adjustably aligning with said at least one water inlet of said float.

11. The water aerating device as claimed in claim 10, wherein said float includes a groove formed in the outer peripheral wall, and said cap includes a peripheral latch rotatably engaged into said groove of said float for rotatably attaching said cap to said float.

12. The water aerating device as claimed in claim 8, wherein said float includes a compartment formed in an outer peripheral wall, and a rotary wheel rotatably disposed in said compartment of said float and having at least one passage formed therein.

13. The water aerating device as claimed in claim 1, wherein said pumping device includes a casing having a chamber formed in said casing for receiving said impeller.

14. The water aerating device as claimed in claim 1, wherein said receptacle includes a ring member disposed on said tube and engaged between said tubular member and said tube, and said ring member includes a notch formed therein and communicating with said annular passageway between said tubular member and said tube for partially blocking said annular passageway between said tubular member and said tube.
